(19) United States
(12) Patent Application Publication
(10) Pub. No.: US 2026/0038492 A1
(43) Pub. Date: Feb. 5, 2026

(54) Audio Content Filtering For Contact Center Agents

(71) Applicant: Zoom Communications, Inc., San Jose, CA (US)

(72) Inventor: Vi Dinh Chau, Seattle, WA (US)

(21) Appl. No.: 18/791,359

(22) Filed: Jul. 31, 2024

(51) Int. Cl. G10L 15/18; G10L 21/034; G10L 25/63; H04M 3/51

(52) U.S. Cl. CPC G10L 15/1815; G10L 21/034; G10L 25/63; H04M 3/5175; H04M 2201/405

(57) ABSTRACT

Audio content filtering is performed to replace audio content initially presented to a contact center agent device from a contact center user device during a contact center engagement. Speech content is obtained at a first device of a contact center agent from a second device of a contact center user during a contact center engagement between the contact center agent and the contact center user. A determination is made, using an artificial intelligence model accessible to the first device, that the speech content meets a threshold. Based on the speech content meeting the threshold, a transcription of the speech content is generated using the artificial intelligence model. The transcription of the speech content is then output in place of the speech content and during the contact center engagement at the first device.

### FIELD

This disclosure generally relates to contact center solutions, and, more specifically, to content filtering for contact center agents.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a contact center system.

FIG. 5 is a block diagram of an example of a system for content filtering for contact center agents.

FIG. 6 is a block diagram of example functionality of content filtering software.

FIG. 7 is a flowchart of an example of a technique for audio content filtering for contact center agents.

FIG. 8 is a flowchart of an example of a technique for visual content filtering for contact center agents.

### DETAILED DESCRIPTION

The use of contact centers by or for service providers is becoming increasingly common to address customer support requests over various modalities, including telephony, video, text messaging, chat, and social media. In one example, a contact center may be implemented by an operator of a software platform, such as a unified communications as a service (UCaaS) platform or a contact center as a service (CCaaS) platform, for a customer of the operator. Users of the customer may engage with the contact center to address support requests over one or more communication modalities enabled for use with the contact center by the software platform. In another example, the operator of such a software platform may implement a contact center to address customer support requests related to the software platform itself.

Customer support requests are addressed within a contact center over contact center engagements between contact center users and contact center agents. A contact center engagement may include a number of interactions between the subject user and the subject agent, for example, questions or statements communicated from one to the other. In many cases, the contact center user is polite and patient with the contact center agent, resulting in a pleasant engagement between them in which the user is hopefully satisfied with the results. However, some contact center users may, due to personality traits or significant challenges in addressing their issues, be impolite and impatient, whether or not due to speech or action of the contact center agent. In those situations where a contact center user becomes combative with the contact center agent, the agent may be unnecessarily exposed to undesirable user behavior such as angry threats or insults, the use of profanity, screams or yells, or harassment speech. Over time, these negative contact center engagements impose a significant toll on the mental health of contact center agents, affecting both their personal wellbeing and their job performance.

Typical approaches for contact center agents handling these negative contact center engagements involve an agent first attempting to de-escalate the situation by using scripted language to calm the contact center user or otherwise redirect their pointed speech into a productive conversation. Where the agent is unable to de-escalate, the agent may be able to transfer the contact center engagement to a supervisor who can join the engagement to address the issues of the contact center user. Unfortunately, these approaches do not work in every situation and may in some cases add to the frustration of the contact center user by delaying what they perceive to be the acceptable conclusion of the contact center engagement. Meanwhile, the contact center agent handling a negative engagement and attempting to de-escalate or transfer it continues to be exposed to the undesirable situation. It would thus be desirable to introduce an automated technical process by which software of or otherwise accessible to the contact center operates to limit or prevent exposure of prolonged negative engagement content to agents.

Implementations of this disclosure address problems such as these using content filtering for contact center agents. In particular, the implementations of this disclosure address approaches for audio content filtering and for visual content filtering, in which the audio and visual content filtering may be separately or concurrently used for a given contact center engagement. Generally, content filtering as used herein refers to a software-automated process for using artificial intelligence (AI), machine learning (ML), or both to determine to filter content involved in a contact center engagement between a contact center user and a contact center agent, in which the contact center user is a human using a computing device referred to as a contact center user device, user device, or end user device and the contact center agent is a human using a computing device referred to as a contact center agent device or agent device.

The implementations hereof directed to audio content filtering for contact center agents include systems and techniques for determining to filter content obtained from a contact center user device during a contact center engagement and outputting a filtered version of that content to a contact center agent device in place of the original, unfiltered version thereof. In particular, audio content, for example, speech content, of a contact center user may be filtered based on one or more factors, including by an AI model trained for sentiment analysis processing the audio content to determine that the speech content indicates a negative emotional state of the contact center user. This negative emotional state may be based on, for example, a negative emotional tone used by the contact center user within the speech content, an amount of profanity used by the contact center user within the speech content, a speech volume used by the contact center user within the speech content, or the like. The AI model obtains the content, determines that the content meets a threshold, and generates filtered content to replace the content. In one example, the filtered content may be a transcribed (i.e., text) version of the content originally obtained from the contact center user device. The outputting of the filtered content at the contact center agent device in place of the original, unfiltered content obtained from the contact center user device limits or prevents exposure of negative engagement content to agents.

The implementations hereof directed to visual content filtering for contact center agents include systems and techniques for determining to filter visual content within a video stream of a contact center agent for a contact center engagement with a contact center user and generating an updated video stream including filtered content that replaces the visual content. In particular, visual content, for example, content depicted within or otherwise corresponding to a background or a foreground of the video stream of the contact center agent may be filtered (e.g., replaced) according to a determination to filter the visual content. For example, a determination may be made to filter the visual content based on a relevance score determined for the visual content, such as according to the relevance score meeting a threshold or being lower than a relevance score determined for the filtered content with which to replace the visual content. The determination may in some cases be made using an AI model. The updated video stream which includes the filtered content is output for rendering at a device of the contact center user during the contact center engagement.

The implementations of this disclosure may thus include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

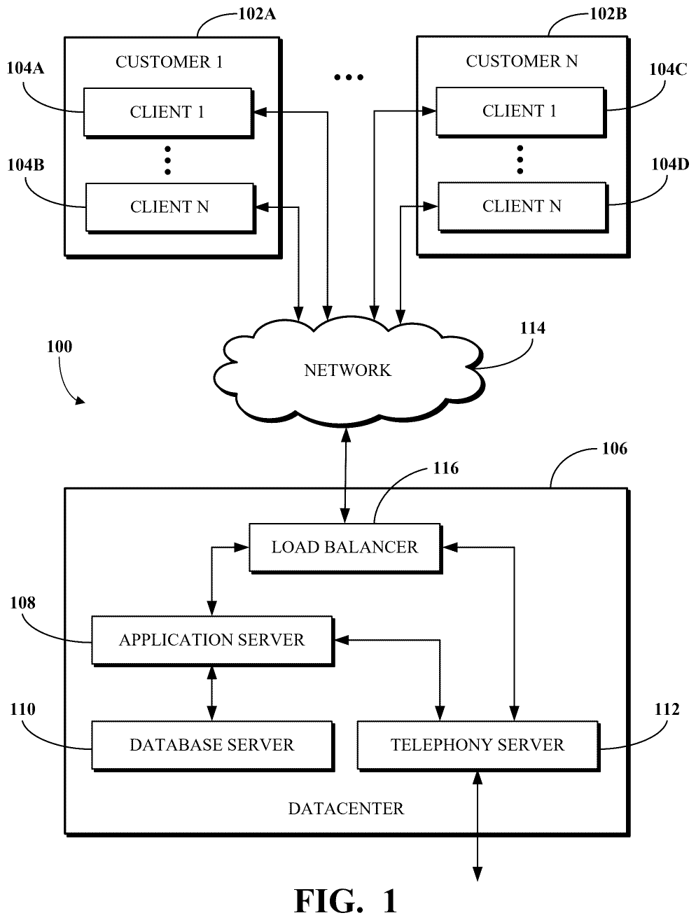

To describe some implementations in greater detail, reference is first made to examples of hardware and software structures used to implement a system for content filtering for contact center agents. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a CCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a CCaaS platform (or, alternatively, of a UCaaS platform). The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The CCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a CCaaS platform. For example, the application server 108 can implement all or a portion of a CCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

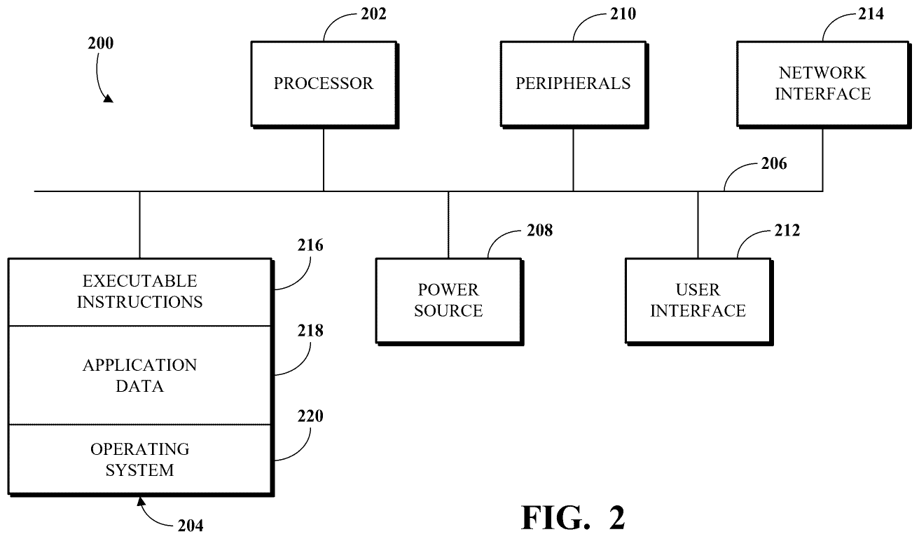

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

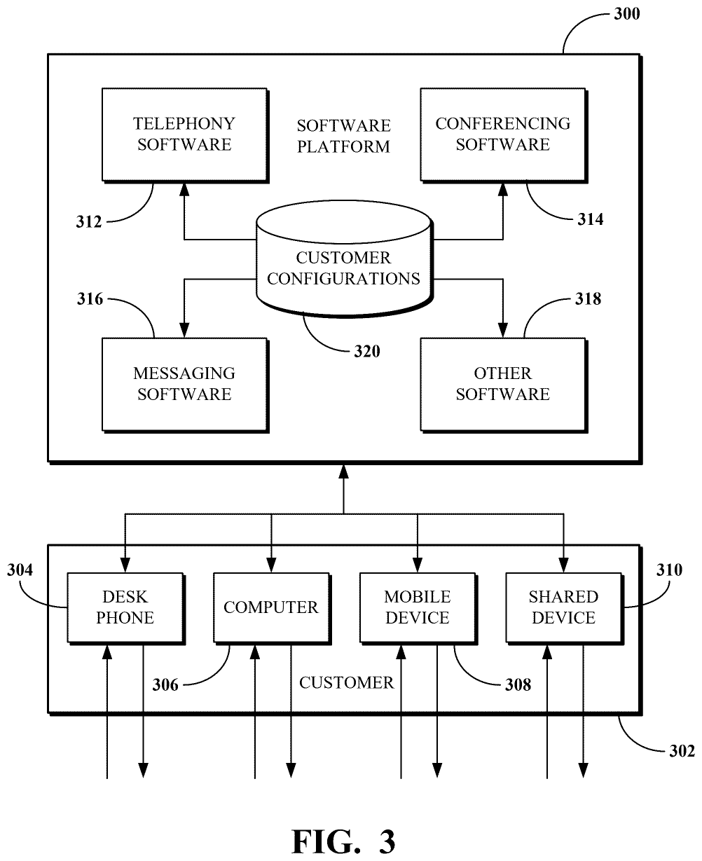

FIG. 3 is a block diagram of an example of a software platform 300 implemented by an electronic computing and communications system, for example, the system 100 shown in FIG. 1. The software platform 300 is a CCaaS platform (or alternatively a UCaaS platform) accessible by clients of a customer of a CCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include contact center software, for example, software for content filtering for contact center agents.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

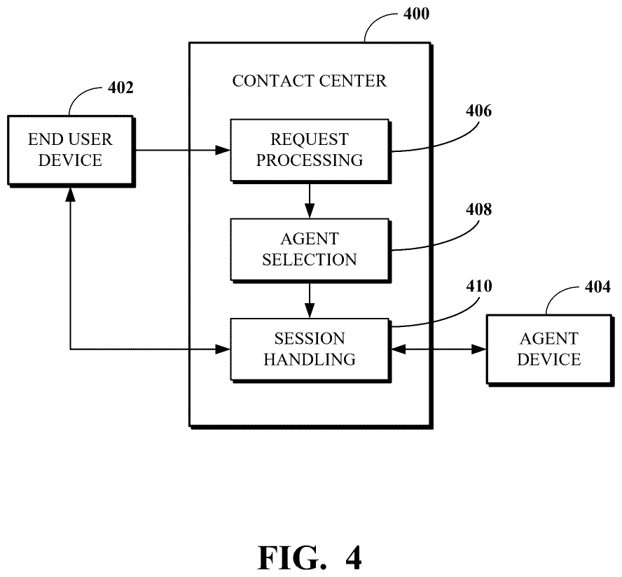

FIG. 4 is a block diagram of an example of a contact center system. A contact center 400, which in some cases may be implemented in connection with a software platform (e.g., the software platform 300 shown in FIG. 3), is accessed by a user device 402 and used to establish a connection between the user device 402 and an agent device 404 over one of multiple modalities available for use with the contact center 400, for example, telephony, video, text messaging, chat, and social media. The contact center 400 is implemented using one or more servers and software running thereon. For example, the contact center 400 may be implemented using one or more of the servers 108 through 112 shown in FIG. 1, and may use communication software such as or similar to the software 312 through 318 shown in FIG. 3. The contact center 400 includes software for facilitating contact center engagements requested by user devices such as the user device 402. As shown, the software includes request processing software 406, agent selection software 408, and session handling software 410.

The request processing software 406 processes a request for a contact center engagement initiated by the user device 402 to determine information associated with the request. The request may include a natural language query or a request entered in another manner (e.g., “press 1 to pay a bill, press 2 to request service”). The information associated with the request generally includes information identifying the purpose of the request and which is usable to direct the request traffic to a contact center agent capable of addressing the request. The information associated with the request may include information obtained from a user of the user device 402 after the request is initiated. For example, for the telephony modality, the request processing software 406 may use an interactive voice response (IVR) menu to prompt the user of the user device to present information associated with the purpose of the request, such as by identifying a category or sub-category of support requested. In another example, for the video modality, the request processing software 406 may use a form or other interactive user interface to prompt a user of the user device 402 to select options which correspond to the purpose of the request. In yet another example, for the chat modality, the request processing software 406 may ask the user of the user device 402 to summarize the purpose of the request (e.g., the natural language query) via text and thereafter process the text entered by the user device 402 using natural language processing and/or other processing.

The session handling software 410 establishes a connection between the user device 402 and the agent device 404, which is the device of the agent selected by the agent selection software 408. The particular manner of the connection and the process for establishing same may be based on the modality used for the contact center engagement requested by the user device 402. The contact center engagement is then facilitated over the established connection. For example, facilitating the contact center engagement over the established connection can include enabling the user of the user device 402 and the selected agent associated with the agent device 404 to engage in a discussion over the subject modality to address the purpose of the request from the user device 402. The facilitation of the contact center engagement over the established connection can use communication software implemented in connection with a software platform, for example, one of the software 312 through 318, or like software.

The user device 402 is a device configured to initiate a request for a contact center engagement which may be obtained and processed using the request processing software 406. In some cases, the user device 402 may be a client device, for example, one of the clients 304 through 310 shown in FIG. 3. For example, the user device 402 may use a client application running thereat to initiate the request for the contact center engagement. In another example, the connection between the user device 402 and the agent device 404 may be established using software available to a client application running at the user device 402. Alternatively, in some cases, the user device 402 may be other than a client device.

The agent device 404 is a device configured for use by a contact center agent. Where the contact center agent is a human, the agent device 404 is a device having a user interface. In some such cases, the agent device 404 may be a client device, for example, one of the clients 304 through 310, or a non-client device. In some such cases, the agent device 404 may be a server which implements software usable by one or more contact center agents to address contact center engagements requested by contact center users. Where the contact center agent is a non-human, the agent device 404 is a device that may or may not have a user interface. For example, in some such cases, the agent device 404 may be a server which implements software of or otherwise usable in connection with the contact center 400.

Although the request processing software 406, the agent selection software 408, and the session handling software 410 are shown as separate software components, in some implementations, some or all of the request processing software 406, the agent selection software 408, and the session handling software 410 may be combined. For example, the contact center 400 may be or include a single software component which performs the functionality of all of the request processing software 406, the agent selection software 408, and the session handling software 410. In some implementations, one or more of the request processing software 406, the agent selection software 408, or the session handling software 410 may be comprised of multiple software components. In some implementations, the contact center 400 may include software components other than the request processing software 406, the agent selection software 408, and the session handling software 410, such as in addition to or in place of one or more of the request processing software 406, the agent selection software 408, and the session handling software 410.

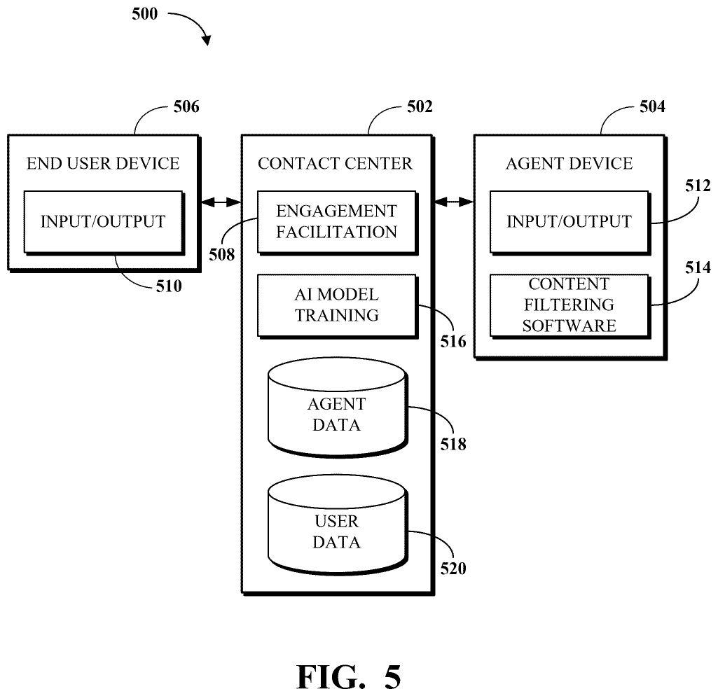

FIG. 5 is a block diagram of an example of a system 500 for content filtering for contact center agents. The system 500 includes a contact center 502, an agent device (also referred to as a contact center agent device) 504, and an end user device (also referred to as a contact center user device) 506, which may, respectively, be the contact center 400, the agent device 404, and the end user device 402 shown in FIG. 4. A user of the end user device 506 (i.e., a contact center user) and a user of the agent device 504 (i.e., a contact center agent) participate in a contact center engagement together via the contact center 502, for example, as described above with respect to FIG. 4. In particular, engagement facilitation software 508 of the contact center 502 facilitates a contact center engagement over a synchronous communication modality, for example, a telephony modality (e.g., via the telephony software 312 shown in FIG. 3) or a video conferencing modality (e.g., via the conferencing software 314 shown in FIG. 3). The end user device 506 and the agent device 504 may each connect to the contact center engagement via clients running at those respective devices or, alternatively, using other software, for example, using non-client mobile applications or web applications. In some cases, one may use a client and another may use such other software.

During the contact center engagement, first content is captured at the end user device 506 and transmitted via the contact center 502 for output at the agent device 504, and other content is captured at the agent device 504 and transmitted via the contact center 502 for output at the end user device 506. The end user device 506 includes input/output components 510 usable to capture the first content at the end user device 506 and to output the second content obtained from the agent device 504. The agent device 504 includes input/output components 512 usable to capture the second content at the agent device 504 and to output the first content obtained from the end user device 506. The input/output components 510 and the input/output components 512 may each be, include, or otherwise correspond to one or more of a microphone, a set of microphones, a camera, a set of cameras, a display, a set of displays, or the like.

The agent device 504 includes (e.g., executes, interprets, or otherwise runs) content filtering software 514. The content filtering software 514 performs content filtering against content captured at the end user device 506 and obtained at the agent device 504 and/or against content captured at the agent device 504 for transmission to the end user device 506. For example, the content filtering software 514 may perform audio content filtering to filter audio content (e.g., speech content) captured using one or more microphones as the input/output components 510 at the end user device 506. One non-limiting example of such audio content filtering may be to determine, as filtered content, a transcription of speech content obtained at the agent device 504 from the end user device 506. In another example, the content filtering software 514 may perform visual content filtering to filter visual content (e.g., a video stream background) within a video stream captured using one or more cameras as the input/output components 512 at the agent device 504. One non-limiting example of such visual content filtering may be to determine, as filtered content, a virtual background to include within a video stream for the agent device 504 to transmit for rendering at the end user device 506.

The content filtering software 514 performs content filtering using an AI model trained by AI model training software 516. The AI model training software 516 is software configured to train an AI model for use in the content filtering performed by the content filtering software 514. In particular, the content filtering software 514 uses an AI model trained by the AI model training software 516 to perform content filtering. For example, the AI model may be deployed to the agent device 504 from a server of the contact center 502 (e.g., a server that includes the AI model training software 516) for the content filtering software 514 to locally use at the agent device 504. In another example, the content filtering software 514 may access the AI model at a server of the contact center as part of the content filtering performance. In either case, the AI model evaluates content obtained from the end user device 506 to determine that the content meets a threshold and, based on the content meeting the threshold, filters the content to cause a filtered version of the content to be output at the agent device 504 instead of an original, unfiltered version of that content. In some cases, the content filtering software 514 may use the AI model to filter content obtained at the agent device 504 for transmission to the end user device 506, for example, by replacing visual aspects of a video stream captured at the agent device 504 before the video stream is transmitted for rendering at the end user device 506.

The AI model training software 516 trains the AI model using one or both of agent data 518 or user data 520. The agent data 518 includes or otherwise refers to data associated with interaction profiles of contact center agents. An interaction profile of a contact center agent generally refers to information that defines how the agent perceives and responds to contact center users as well as agent preferences for how to handle content filtering. For example, an interaction profile for the agent who uses the agent device 504 can be generated over time via manual input obtained from the agent device 504 and/or by the AI model training software 516 observing and inferring agent behaviors over time. The interaction profile can indicate whether the agent prefers for audio content of a contact center user to be converted to text or reduced in tone. The agent data 518 generally refers to multiple contact center agents and may in some cases correspond to all agents of the contact center 502. However, in some cases, the agent data 518 may be limited to the agent group or team with which the agent using the agent device 504 is associated or otherwise to that single agent themselves.

The user data 520 includes or otherwise refers to identity-agnostic information generally representative of users, and thus excludes data usable to identify individual contact center users or otherwise indicative of their identities. For example, the user data 520 may correspond to records of past determinations of negative emotional states, heightened volume usage, frequent profanity usage, or the like for contact center users. In another example, the user data 520 may indicate location or region information for users, which can be indicative of cultural aspects of user content (e.g., by identifying when a contact center user is connecting to the contact center 502 from a region in which profanity is commonly used in the dialect). In some cases, the user data 520 may in any event be obtained via an opt-in or opt-out process in connection with a use of the contact center 502 by the users. The AI model training software 516 trains the AI model using the agent data 518 and/or the user data 520 to cause the trained AI model to recognize patterns in agent and/or user behaviors and to determine when a given behavior is beyond established normal values.

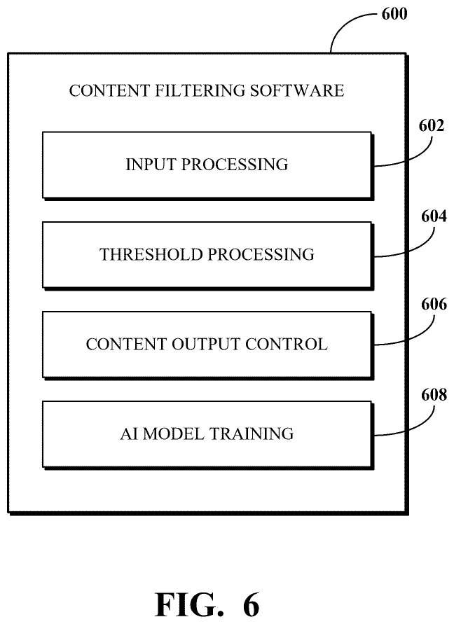

To further describe the content filtering software 514, reference is made to FIG. 6, which is a block diagram of example functionality of the content filtering software 514. The content filtering software 514 includes tools, such as programs, subprograms, functions, routines, subroutines, operations, and/or the like for filtering contact center content during contact center engagements. As shown, the contact center software 514 includes an input processing tool 600, a threshold processing tool 602, a content output control tool 604, and an AI model training tool 606. The tools 600 through 606 are shown by example. As such, in some implementations, the contact center software 514 may include one or more other tools in addition to and/or in place of one or more of the tools 600 through 606. Moreover, while the tools 600 through 606 are shown and described as being part of software at the agent device 504, in some implementations, the content filtering software 514 or otherwise one or more of the tools 600 through 606 may instead be included elsewhere, for example, a server (or multiple servers) of the contact center 502.

The input processing tool 600 obtains, as input, content transmitted from or content to be transmitted to a contact center user device (e.g., the end user device 506 shown in FIG. 5) during a contact center engagement with a contact center agent device (e.g., the agent device 504 shown in FIG. 5). In one example, the content is speech content obtained at the agent device from the user device. The speech content may include or otherwise correspond to one or more words in one or more languages and/or to lingual tones, noises, tone or noise qualities, or the like. Thus, the speech content may represent specific words, tones, volumes, or the like. In another example, the content is visual content used in a video stream of the agent device and for transmission to the user device. The visual content may include or otherwise correspond to one or more of a background of the video stream, a portion of the background, a foreground of the video stream (i.e., a portion of the video stream that depicts the agent using the agent device), a portion of the foreground, or another aspect of the video stream or a combination thereof. Thus, the visual content may represent specific aspects of how the agent presents visually to the user. The input processing tool 600 may obtain the content via one or more input/output components of the agent device, for example, the input/output components 512 shown in FIG. 5. In some cases, the input processing tool 600 may process visual content indicative of gestures from the contact center user device or the contact center agent device.

The threshold processing tool 602 evaluates the content obtained by or otherwise using the input processing tool 600 against one or more thresholds. A threshold used by the threshold processing tool 602 is a measurement of a value limit that once met (i.e., reached or exceeded) results in some filtering action being performed against the content obtained by or otherwise using the input processing tool 600. Each threshold of the one or more thresholds may correspond to a different aspect of such content. For example, a first threshold may correspond to a negative emotional tone or an amount of such a tone used by contact center users within speech content. In another example, a second threshold may correspond to profanity or an amount of such profanity used by contact center users within speech content. In yet another example, a third threshold may correspond to a speech volume or a fluctuation of such volume used by contact center users within speech content. In still another example, a fourth threshold may correspond to a use within a video stream (e.g., of a contact center agent) of a background that does not relate to a contact center user (e.g., a company or other organization with which the user is associated).

The one or more thresholds used by the threshold processing tool 602 may be defined by an AI model, for example, the AI model trained by or otherwise using the AI model training software 516 shown in FIG. 5. For example, the AI model can indicate, based on training data sets comprising inputs of the agent data 518 and/or the user data 520 shown in FIG. 5 and used by the AI model training software 516 to train the AI model, values for aspects of content that result in a response. For example, the AI model determine a threshold amount of profanity that, when used by contact center users during contact center engagements, typically results in contact center agents attempting to de-escalate users. In another example, the AI model may determine a threshold speech volume or a threshold speech volume fluctuation that, when used by contact center users during contact center engagements, typically results in contact center agents attempting to de-escalate users.

In some cases, the one or more thresholds may be defined specifically for a given contact center user or agent, for example, the user of the end user device 506 or of the agent device 504. In some cases, one or more of the thresholds used by the threshold processing tool 602 may be empirically determined, other than using an AI model. In some cases, the one or more thresholds may be binary measurements. For example, a threshold may be met where any amount of screaming is detected within content obtained from a contact center user device. In another example, a threshold may be met where a contact center agent video stream background does not correspond to a company or other organization with which the user is associated.

The AI model may be trained, either exclusively or amongst other purposes, for sentiment analysis to determine emotional states of contact center users based on content obtained by or otherwise using the input processing tool 600. For example, the AI model can determine sentiment-based scores for contact center engagements between contact center users and contact center agents. A sentiment-based score represents a measure of sentiment at a given moment during or otherwise for a contact center engagement. A measure of sentiment generally refers to or otherwise indicates a feeling of the subject contact center user based on the words and/or expressions of the subject contact center user and/or of the contact center agent during the engagement. The sentiment-based score is a value determined to represent that measure of sentiment using contextual processing of a conversation between the user and agent occurring during the engagement.

There may be many modeled approaches which may be used to determine the sentiment-based score. For example, various variables may be defined according to linguistic, contextual, and like modeling to weight the relative value of certain words, tones, inflections, phrases, pauses, speech volumes, speech speeds, or the like or a combination thereof, either on their own or in a specific context of use (e.g., based on neighboring words or phrases). In some cases, a model used to determine a sentiment-based score for a contact center engagement may change over time, such as based on learned understandings of idiosyncrasies or other language or expression perception specific to one or more contact center users and/or agents.

A sentiment-based score may be determined for a contact center engagement at one or more times during the contact center engagement. For example, a sentiment-based score may be determined based on triggering events detected during the engagement, such as based on certain words, tones, inflections, phrases, pauses, speech volumes, or speech speeds. In another example, a sentiment-based score may be determined based on some or all interactions during the contact center engagement regardless of the specific sentiment associated with those interactions. In some such cases, the sentiment-based score may be considered to be determined for each such interaction. In other such cases, the sentiment-based score may be considered to be determined for a first such interaction and then updated based on each subsequent such interaction. In yet another example, a sentiment-based score may be determined at predetermined or other times during the contact center engagement, such as once every thirty seconds or once per minute.

In some cases, where a record of a prior contact center engagement for the same contact center user is available within the contact center system, an initial value of the sentiment-based score for the current contact center engagement involving the user is based on a last or other sentiment-based score determined during that prior contact center engagement. In this way, the sentiment analysis may follow the contact center user across multiple contact center engagements. This may be particularly useful to prioritize engagements with that user for participation by another agent or supervisor, such as where the initial value determined based on that recent prior contact center engagement indicates or otherwise corresponds to a relatively low customer satisfaction of that user. In other cases, such as where the contact center user is a first-time user of the contact center or otherwise, an initial value of the sentiment-based score may simply be the first sentiment-based score determined for the contact center engagement.

In some cases, the AI model may perform the threshold processing according to a location or region in which the contact center user and/or the contact center agent is located. For example, where the contact center user is located within a region reputed for its high or otherwise frequent use of profanity in casual conversation, and thus in which the use of profanity is not an indicator of a negative emotional state of the contact center user, the AI model may use a secondary threshold for profanity use that measures a heightened amount for even users within that subject region. In another example, where the contact center user is located within a region reputed for its common use of gestures or gesticulation, and thus in which the use of gestures or of gesticulation is not an indicator of a negative emotional state of the contact center user, the AI model may use a secondary threshold for gesture or gesticulation use that measures a heightened amount for even users within that subject region.

The content output control tool 604 performs content filtering based on determinations made according to or otherwise by or using the threshold processing tool 602. Content filtering includes processing an initial version of content to determine (e.g., generate) a filtered version of that content, also referred to as filtered content. Non-limiting examples of content filtering include muting an audio signal from a contact center user device, normalizing a speech tone within such an audio signal, transcribing the speech into a text format, or the like. The filtered content will be output during the contact center engagement in place of the content as originally obtained. The content filtering can include determining the filtered content by changing substantive aspects of the content and/or by changing a format of the content. For example, changing the format of the content can include using automated speech recognition (ASR) or like natural language processing (NLP) to generate a transcription representing a text format of speech content originally obtained in an audio signal. In another example, changing a substantive aspect of the content can include replacing profanity with bleep noises or normalizing a speech volume.

The content output control tool 604 uses the AI model used by the threshold processing tool 602 to perform the content filtering. Generally, the content filtering is performed based on a determination, by or otherwise using the threshold processing tool 602, that a threshold has been met by content obtained by or otherwise using the input processing tool 600. Based on that determination, the content output control tool 604 uses the AI model for content filtering beginning at or near the time of determination and extending through the remainder of the contact center engagement. The content filtering is performed in regard to a specific type of the content with which the met threshold is associated. For example, where the threshold is a speech volume threshold, content filtering is performed to normalize or otherwise decrease the speech volume of the content, but will not be performed to filter profanity or address negative emotional tones unless thresholds corresponding to those aspects are also met. Content filtering may thus include, based on the applicable thresholds met, one or more of transcription generation, audio signal modulation, or the like. In some cases, the content filtering may be discontinued during the contact center engagement. For example, where the threshold processing tool 604 determines that second content obtained after the original content, either in an single instance or upon a threshold period of time elapsing, no longer meets the applicable threshold, the content filtering may be discontinued. In another example, where the agent themselves manually provides input indicating to discontinue such content filtering, the content filtering may be discontinued.

In some cases, the content output control tool 604 may additionally or alternatively present visual output for display at the contact center agent device. For example, the visual output may be, include, or otherwise correspond to an indication that filtering has been performed against content obtained from the contact center user device. In such a case, the visual output is an indicator usable to indicate to the agent that the content being output at their device is not identical to the content obtained from the user, whether in substance and/or format. In another example, the visual output may be, include, or otherwise correspond to an alert indicating, based on processing by the threshold processing tool 602 (e.g., using an AI model), an expected, developing, or determined negative emotional state of the contact center user. In such a case, the visual output is an indicator usable to indicate to the agent that there is an issue with user sentiment of which the agent should be aware. In some cases, the visual output may correspond to guidance usable by a contact center agent to address (e.g., de-escalate) the user. For example, the visual output may include scripted language obtained from a knowledgebase or generated in real-time (e.g., using the AI model or a generative AI model).

The AI model training tool 606 collects data usable for fine tuning (e.g., further training) the AI model used by the content filtering software 514. In particular, the AI model training tool may obtain input data automatically (i.e., without action by the contact center agent) or manually (i.e., based on an action by the contact center agent). One non-limiting example of automatically obtained input data includes the AI model training tool 606 collecting data indicative of agent sentiment before and after the content filtering occurred to determine whether the agent sentiment improved during the contact center engagement as a result of any of the applicable content filtering. For example, the agent sentiment can be evaluated in a manner as described above with respect to an AI model trained for sentiment analysis, in which the AI model processes content of the contact center agent to determine occurrences of negative agent emotion and to correlate those occurrences with contact center user behavior. One non-limiting example of manually obtained input data includes the agent indicating aspects of the content filtering that improved their sentiment during the contact center engagement.

In some implementations, software at the contact center 502 may maintain a record of a number of negative contact center engagements the agent using the agent device 504 has handled in a given period of time (e.g., within a past 30 minutes, during a single shift, over a 24-hour period, or throughout a work week). For example, the number of negative contact center engagements may be increased by one for each contact center engagement during which the content obtained from the end user device 506 meets a threshold (e.g., where a negative emotional tone used by the contact center user within the speech content, an amount of profanity used by the contact center user within the speech content, and/or a speech volume used by the contact center user within the speech content meets the threshold). Once the number of negative contact center engagements meets an engagement threshold, meaning the contact center agent has handled at least the engagement threshold number of negative contact center engagements, the engagement facilitation software 508 (e.g., via the agent selection software 408 shown in FIG. 4) may limit or otherwise prevent the further routing of contact center engagements expected to be negative contact center engagements to the contact center agent until the period of time has elapsed. For example, the engagement facilitation software 508 may determine (e.g., predict a negative contact center engagement based on initial input obtained from the end user device 506 during request processing (e.g., by the request processing software 406 shown in FIG. 4 determining that the threshold against which content obtained from the end user device 506 is to be compared is or may be met based on speech content or like input obtained from the end user device 506 before same is connected to an agent device.

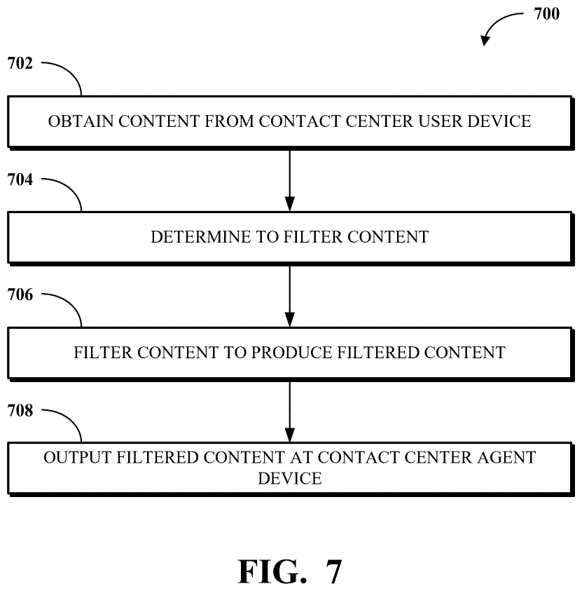

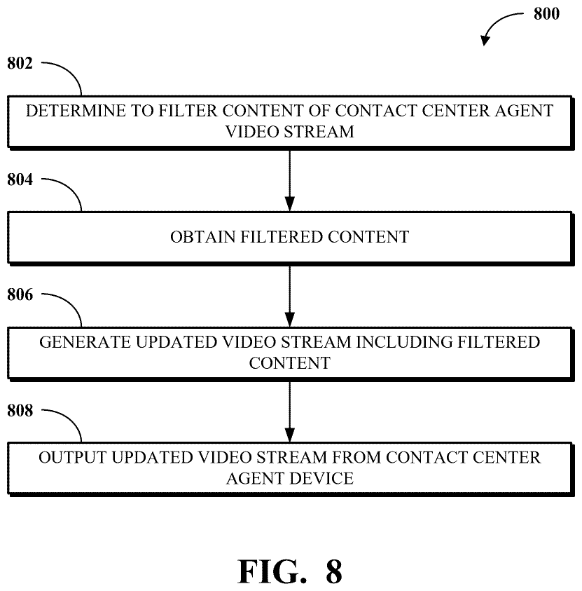

To further describe some implementations in greater detail, reference is next made to examples of techniques which may be performed by or using a system for content filtering for contact center agents. FIG. 7 is a flowchart of an example of a technique 700 for audio content filtering for contact center agents. FIG. 8 is a flowchart of an example of a technique 800 for visual content filtering for contact center agents.

The technique 700 and/or the technique 800 can be executed using computing devices, such as the systems, hardware, and software described with respect to FIGS. 1-6. The technique 700 and/or the technique 800 can be performed, for example, by executing a machine-readable program or other computer-executable instructions, such as routines, instructions, programs, or other code. The steps, or operations, of the technique 700, the technique 800, and/or another technique, method, process, or algorithm described in connection with the implementations disclosed herein can be implemented directly in hardware, firmware, software executed by hardware, circuitry, or a combination thereof.

For simplicity of explanation, the technique 700 and the technique 800 are each depicted and described herein as a series of steps or operations. However, the steps or operations of the technique 700, the technique 800, and/or any other technique in accordance with this disclosure, can occur in various orders and/or concurrently. Additionally, other steps or operations not presented and described herein may be used. Furthermore, not all illustrated steps or operations may be required to implement such a technique in accordance with the disclosed subject matter.

Referring first to FIG. 7, the technique 700 for audio content filtering for contact center agents is shown. At 702, content is obtained from a contact center user device (i.e., a device of a contact center user). The content is audio content obtained within an audio signal via a contact center system through which a contact center engagement between a first device of a contact center agent and a second device of a contact center user is facilitated. For example, the contact center engagement may be facilitated, and the content thus obtained, over a synchronous communication modality, such as a telephony modality or a video conferencing modality. The content may in particular include speech content, which may include human speech in one or more spoken human languages and/or vocal aspects such as inflections, grunts, sighs, or the like.

At 704, a determination is made to filter the content. The determination is made using an AI model accessible to the first device. Determining to filter the content includes determining that the content (e.g., the speech content) meets a threshold. For example, determining that the speech content meets the threshold can include one or more of determining that a negative emotional tone used by the contact center user within the speech content meets the threshold, determining that an amount of profanity used by the contact center user within the speech content meets the threshold, or determining that a speech volume used by the contact center user within the speech content meets the threshold. The threshold may be specific to the contact center agent or applicable to multiple contact center agents. In some cases, the determination is based on the threshold being met for a threshold period of time (e.g., one consecutive minute) during the contact center engagement. In some cases, the determination is based on the content cumulatively meeting the threshold over multiple periods of time during the contact center engagement. The AI model may, for example, be trained for sentiment analysis using contact center engagement data associated with at least one past contact center engagement for each of multiple contact center agents and the threshold is used with the contact center agent and other contact center agents. In another example, the AI model may be trained for sentiment analysis using contact center engagement data limited to the contact center agent and the threshold is specific to the contact center agent.

At 706, the content is filtered to produce filtered content. The filtering is performed based on the content meeting the threshold. Filtering the content to produce the filtered content can include modulating aspects of an audio signal from which the content is obtained, translating the content from a first format to a second format, or both. For example, producing the filtered content can include generating, using the AI model, a transcription of the speech content. In another example, producing the filtered content can include muting an audio channel of the contact center user to prevent an output of the speech content or additional content at the first device during at least some remaining amount of the contact center engagement.

At 708, the filtered content is output at the contact center agent device. Outputting the filtered content includes causing the contact center agent device to output (e.g., via a speaker and/or display of the contact center agent device) the filtered content. In some cases, outputting the filtered content can include outputting (e.g., in connection with the transcription of the content or otherwise) an indication of a negative emotional state of the contact center user.

Referring next to FIG. 8, the technique 800 for visual content filtering for contact center agents is shown. At 802, a determination is made to filter content of a contact center agent video stream. For example, determining to filter the visual content of the video stream of the contact center agent for the contact center engagement with the contact center user can include one or more of determining that the filtered content corresponds to the contact center user, determining that a first relevance score associated with the visual content is lower than a second a second relevance score associated with the filtered content, or determining that a relevance score associated with the visual content meets a threshold. The content may, for example, correspond to one or more of a background of the video stream or a foreground of the video stream. For example, the foreground may include a depiction of the contact center agent and the background may include a remainder of the depictions within the video stream. In some cases, the determination to filter the visual content may be made before the contact center engagement starts, for example, while the contact center user is being routed to the agent for handling.

At 804, filtered content is obtained. The filtered content corresponds to the determination to filter the visual content. For example, obtaining the filtered content can include accessing the filtered content within a library or other data store accessible to the device of the contact center agent. Thus, where the visual content corresponds to a background of the video stream, obtaining the filtered content can include obtaining, as the filtered content, a virtual background from a library accessible to the agent device. In another example, obtaining the filtered content can include generating the filtered content. For example, an AI model trained for use with the contact center engagement can be used to obtain the filtered content. Thus, where the visual content corresponds to a background of the video stream, obtaining the filtered content can include generating, as the filtered content, a virtual background.

At 806, an updated video stream including the filtered content is generated. Generating the updated video stream includes replacing the visual content with the filtered content. For example, generating the updated video stream can include asserting a filter against a foreground of the video stream to replace the visual content with the filtered content. In another example, generating the updated video stream can include combining a foreground of the video stream and a virtual background, as the filtered content, to generate the updated video stream.

At 808, the updated video stream is output from the contact center agent device. In particular, the updated video stream is output in place of the original video stream for rendering at a device of the contact center user during the contact center engagement.

In some implementations, the technique 800 may operate to filter visual content other than visual content of a contact center agent video stream. For example, the technique 800 may be performed to filter visual content obtained from a video stream of a contact center user device. In some such cases, the threshold processing, which may use an AI model as described above, is performed to determine whether to filter that contact center user visual content. For example, the AI model may take, as input, a set of frames of the contact center user video stream and perform processing against those frames to detect visual content such as gestures or gesticulations, facial expressions, or the like which may be associated with or have potential relevance toward negative emotional states of the contact center user.

The implementations of this disclosure describe methods, systems, devices, apparatuses, and non-transitory computer readable media for audio content filtering for contact center agents. In some implementations, a method comprises, a non-transitory computer readable medium stores instructions operable to cause one or more processors to perform operations comprising, and/or a system comprises a memory subsystem storing instructions and processing circuitry configured to execute the instructions for: obtaining, at a first device of a contact center agent, speech content from a second device of a contact center user during a contact center engagement between the contact center agent and the contact center user; determining, using an artificial intelligence model accessible to the first device, that the speech content meets a threshold; based on the speech content meeting the threshold, generating, using the artificial intelligence model, a transcription of the speech content; and outputting, in place of the speech content and during the contact center engagement, the transcription of the speech content at the first device.

In some implementations of the method, the non-transitory computer readable medium, and/or the system, determining that the speech content meets the threshold comprises: determining that a negative emotional tone used by the contact center user within the speech content meets the threshold.

In some implementations of the method, the non-transitory computer readable medium, and/or the system, determining that the speech content meets the threshold comprises: determining that an amount of profanity used by the contact center user within the speech content meets the threshold.

In some implementations of the method, the non-transitory computer readable medium, and/or the system, determining that the speech content meets the threshold comprises: determining that a speech volume used by the contact center user within the speech content meets the threshold.

In some implementations of the method, the non-transitory computer readable medium, and/or the system, outputting the transcription of the speech content at the first device comprises: outputting, in connection with the transcription of the speech content, an indication of a negative emotional state of the contact center user.

In some implementations of the method, the non-transitory computer readable medium, and/or the system, the method comprises, the operations comprise, and/or the processing circuitry is configured to execute the instructions for: based on the speech content meeting the threshold, muting an audio channel of the contact center user to prevent an output of the speech content or additional content at the first device during at least some remaining amount of the contact center engagement.

In some implementations of the method, the non-transitory computer readable medium, and/or the system, the artificial intelligence model is trained for sentiment analysis using contact center engagement data associated with at least one past contact center engagement for each of multiple contact center agents and the threshold is used with the contact center agent and other contact center agents.

In some implementations of the method, the non-transitory computer readable medium, and/or the system, the artificial intelligence model is trained for sentiment analysis using contact center engagement data limited to the contact center agent and the threshold is specific to the contact center agent.

In some implementations of the method, the non-transitory computer readable medium, and/or the system, the threshold corresponds to one or more of a negative emotional tone, an amount of profanity, or a speech volume.

In some implementations of the method, the non-transitory computer readable medium, and/or the system, the threshold is specific to the contact center agent.

In some implementations of the method, the non-transitory computer readable medium, and/or the system, an indication of a negative emotional state of the contact center user is output in connection with the transcription of the speech content.

In some implementations of the method, the non-transitory computer readable medium, and/or the system, audio from the second device is muted at the first device based on the speech content meeting the threshold.

In some implementations of the method, the non-transitory computer readable medium, and/or the system, the speech content is obtained over a synchronous communication modality.

In some implementations of the method, the non-transitory computer readable medium, and/or the system, determining that the speech content meets the threshold comprises: determining that the speech content meets the threshold for a threshold period of time during the contact center engagement.

In some implementations of the method, the non-transitory computer readable medium, and/or the system, determining that the speech content meets the threshold comprises: determining that the speech content cumulatively meets the threshold over multiple periods of time during the contact center engagement.

In some implementations of the method, the non-transitory computer readable medium, and/or the system, the method comprises, the operations comprise, and/or the processing circuitry is configured to execute the instructions for: based on the speech content meeting the threshold, indicating a negative emotional state of the contact center user at the first device.

In some implementations of the method, the non-transitory computer readable medium, and/or the system, the method comprises, the operations comprise, and/or the processing circuitry is configured to execute the instructions for: based on the speech content meeting the threshold, muting audio of the second device.

In some implementations of the method, the non-transitory computer readable medium, and/or the system, the contact center engagement is facilitated over a telephony modality or a video conferencing modality.

The implementations of this disclosure describe methods, systems, devices, apparatuses, and non-transitory computer readable media for visual content filtering for contact center agents. In some implementations, a method comprises, a non-transitory computer readable medium stores instructions operable to cause one or more processors to perform operations comprising, and/or a system comprises a memory subsystem storing instructions and processing circuitry configured to execute the instructions for: determining, at a first device of a contact center agent, to filter visual content of a video stream of the contact center agent for a contact center engagement with a contact center user; obtaining, at the first device, filtered content corresponding to the determination to filter the visual content; generating, at the first device, an updated video stream by replacing the visual content with the filtered content; and outputting, in place of the video stream, the updated video stream for rendering at a second device of the contact center user during the contact center engagement.

In some implementations of the method, the non-transitory computer readable medium, and/or the system, determining to filter the visual content of the video stream of the contact center agent for the contact center engagement with the contact center user comprises: determining that the filtered content corresponds to the contact center user.

In some implementations of the method, the non-transitory computer readable medium, and/or the system, determining to filter the visual content of the video stream of the contact center agent for the contact center engagement with the contact center user comprises: determining that a first relevance score associated with the visual content is lower than a second a second relevance score associated with the filtered content.

In some implementations of the method, the non-transitory computer readable medium, and/or the system, determining to filter the visual content of the video stream of the contact center agent for the contact center engagement with the contact center user comprises: determining that a relevance score associated with the visual content meets a threshold.

In some implementations of the method, the non-transitory computer readable medium, and/or the system, the visual content corresponds to a background of the video stream and obtaining the filtered content corresponding to the determination to filter the visual content comprises: obtaining, as the filtered content, a virtual background from a library accessible to the first device.

In some implementations of the method, the non-transitory computer readable medium, and/or the system, the visual content corresponds to a background of the video stream and obtaining the filtered content corresponding to the determination to filter the visual content comprises: generating, as the filtered content, a virtual background.

In some implementations of the method, the non-transitory computer readable medium, and/or the system, the visual content corresponds to a foreground of the video stream and generating the updated video stream by replacing the visual content with the filtered content comprises: asserting a filter against the foreground of the video stream to replace the visual content with the filtered content.

In some implementations of the method, the non-transitory computer readable medium, and/or the system, the visual content corresponds to a background of the video stream and generating the updated video stream by replacing the visual content with the filtered content comprises: combining a foreground of the video stream and a virtual background, as the filtered content, to generate the updated video stream.

In some implementations of the method, the non-transitory computer readable medium, and/or the system, the visual content corresponds to a background of the video stream.

In some implementations of the method, the non-transitory computer readable medium, and/or the system, the visual content corresponds to a foreground of the video stream.

In some implementations of the method, the non-transitory computer readable medium, and/or the system, the determination to filter the visual content is based on a relevance score determined for the visual content meeting a threshold.

In some implementations of the method, the non-transitory computer readable medium, and/or the system, the determination to filter the visual content is based on a first relevance score determined for the visual content being lower than a second relevance score determined for the filtered content.

In some implementations of the method, the non-transitory computer readable medium, and/or the system, the determination to filter the visual content is made prior to a start of the contact center engagement.

In some implementations of the method, the non-transitory computer readable medium, and/or the system, determining to filter the visual content of the video stream of the contact center agent for the contact center engagement with the contact center user comprises: determining a relevance score for the visual content; and determining that the relevance score meets a threshold.

In some implementations of the method, the non-transitory computer readable medium, and/or the system, determining to filter the visual content of the video stream of the contact center agent for the contact center engagement with the contact center user comprises: determining a first relevance score for the visual content; determining a second relevance score for the filtered content; and determining that the first relevance score is lower than the second relevance score.

In some implementations of the method, the non-transitory computer readable medium, and/or the system, the visual content corresponds to a background of the video stream and determining to filter the visual content of the video stream of the contact center agent for the contact center engagement with the contact center user comprises: determining that a virtual background, as the filtered content, corresponds to an organization with which the contact center user is associated.

In some implementations of the method, the non-transitory computer readable medium, and/or the system, the method comprises, the operations comprise, and/or the processing circuitry is configured to execute the instructions for: obtaining input from the first device indicating to update the video stream according to the filtered content.

In some implementations of the method, the non-transitory computer readable medium, and/or the system, the contact center engagement is facilitated over a video conferencing modality.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining, at a first device of a contact center agent, speech content from a second device of a contact center user during a contact center engagement between the contact center agent and the contact center user;
determining, using an artificial intelligence model accessible to the first device, that the speech content meets a threshold;
based on the speech content meeting the threshold, generating, using the artificial intelligence model, a transcription of the speech content; and
outputting, in place of the speech content and during the contact center engagement, the transcription of the speech content at the first device.

2. The method of claim 1, wherein determining that the speech content meets the threshold comprises:
determining that a negative emotional tone used by the contact center user within the speech content meets the threshold.

3. The method of claim 1, wherein determining that the speech content meets the threshold comprises:
determining that an amount of profanity used by the contact center user within the speech content meets the threshold.

4. The method of claim 1, wherein determining that the speech content meets the threshold comprises:
determining that a speech volume used by the contact center user within the speech content meets the threshold.

5. The method of claim 1, wherein outputting the transcription of the speech content at the first device comprises:
outputting, in connection with the transcription of the speech content, an indication of a negative emotional state of the contact center user.

6. The method of claim 1, comprising:
based on the speech content meeting the threshold, muting an audio channel of the contact center user to prevent an output of the speech content or additional content at the first device during at least some remaining amount of the contact center engagement.

7. The method of claim 1, wherein the artificial intelligence model is trained for sentiment analysis using contact center engagement data associated with at least one past contact center engagement for each of multiple contact center agents and the threshold is used with the contact center agent and other contact center agents.

8. The method of claim 1, wherein the artificial intelligence model is trained for sentiment analysis using contact center engagement data limited to the contact center agent and the threshold is specific to the contact center agent.

9. A non-transitory computer readable medium storing instructions operable to cause one or more processors to perform operations comprising:
obtaining, at a first device of a contact center agent, speech content from a second device of a contact center user during a contact center engagement between the contact center agent and the contact center user;
determining, using an artificial intelligence model accessible to the first device, that the speech content meets a threshold;
based on the speech content meeting the threshold, generating, using the artificial intelligence model, a transcription of the speech content; and
outputting, in place of the speech content and during the contact center engagement, the transcription of the speech content at the first device.

10. The non-transitory computer readable medium of claim 9, wherein the threshold corresponds to one or more of a negative emotional tone, an amount of profanity, or a speech volume.

11. The non-transitory computer readable medium of claim 9, wherein the threshold is specific to the contact center agent.

12. The non-transitory computer readable medium of claim 9, wherein an indication of a negative emotional state of the contact center user is output in connection with the transcription of the speech content.

13. The non-transitory computer readable medium of claim 9, wherein audio from the second device is muted at the first device based on the speech content meeting the threshold.

14. The non-transitory computer readable medium of claim 9, wherein the speech content is obtained over a synchronous communication modality.

15. A system, comprising:
a memory subsystem; and
processing circuitry configured to execute instructions stored in the memory subsystem to:
obtain, at a first device of a contact center agent, speech content from a second device of a contact center user during a contact center engagement between the contact center agent and the contact center user;
determine, using an artificial intelligence model accessible to the first device, that the speech content meets a threshold;
based on the speech content meeting the threshold, generate, using the artificial intelligence model, a transcription of the speech content; and
output, in place of the speech content and during the contact center engagement, the transcription of the speech content at the first device.

16. The system of claim 15, wherein, to determine that the speech content meets the threshold, the processing circuitry is configured to execute the instructions to:
determine that the speech content meets the threshold for a threshold period of time during the contact center engagement.

17. The system of claim 15, wherein, to determine that the speech content meets the threshold, the processing circuitry is configured to execute the instructions to:
determine that the speech content cumulatively meets the threshold over multiple periods of time during the contact center engagement.

18. The system of claim 15, wherein the processing circuitry is configured to execute the instructions to:
based on the speech content meeting the threshold, indicate a negative emotional state of the contact center user at the first device.

19. The system of claim 15, wherein the processing circuitry is configured to execute the instructions to:
based on the speech content meeting the threshold, mute audio of the second device.

20. The system of claim 15, wherein the contact center engagement is facilitated over a telephony modality or a video conferencing modality.
